(19) United States
(12) Patent Application Publication
(10) Pub. No.: US 2026/0145769 A1
(43) Pub. Date: May 28, 2026

(54) DEVICES AND METHODS FOR FIRE PROTECTION AND HEAT SHIELDING OF FILTER BOWLS

(71) Applicant: OHNOH2O, LLC, Lake Worth, FL (US)

(72) Inventor: Brian Benedict, Lake Worth, FL (US)

(21) Appl. No.: 19/341,892

(22) Filed: Sep. 26, 2025

Related U.S. Application Data
(60) Provisional application No. 63/700,266, filed on Sep. 27, 2024.

(51) Int. Cl. B63H 21/38; A62C 3/06; B01D 35/00; B01D 35/14

(52) U.S. Cl. CPC B63H 21/38; A62C 3/065; B01D 35/005; B01D 35/14

(57) ABSTRACT

A fire and protection system designed to provide fire protection/heat shielding for fuel filter clear bowls to pass a fire test as required by ABYC standards. The fire and protection system comprises a backplate and a clear fuel filter bowl shield.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 63/700,266 , entitled “DEVICES AND METHODS FOR FIRE PROTECTION AND HEAT SHIELDING OF FILTER BOWLS”, filed Sep. 27, 2025. The contents of the above referenced application are incorporated herein by reference in their entirety.

### FIELD OF THE INVENTION

Embodiments of the invention are directed towards devices and methods useful in the marine boating industry; and more particularly, to devices and methods which provide fire protection and heat shielding of fuel filter bowls.

### BACKGROUND OF THE INVENTION

Boats, as do most engine driven devices, use gasoline or diesel fuel to operate. Impurities and/or water mixed with gasoline or diesel can be problematic for these engine driven devices. Water in boat engines often prevents the boat from operating smoothly, and, in many cases, from running at all. The risk of the engines failing to operate can result in a boat user being stuck in open waters, unable to safely navigate the marine vessel. This can result in a very dangerous situation, as the boat may only be capable of drifting through the water.

Because of the potential danger of water in the boat engine, most boat owners have developed systematic checks to prevent this from occurring. Typically, fuel water separators on the boat engine are visually checked to determine if water is accumulating in the fuel system. These fuel water separators often have a fluid collecting canister to aid the boat owner in determining if water has accumulated in the fuel system. Because water and gasoline do not mix and both have different densities, a boat user can see the separation between the two solutions when accumulated within the canister.

The American Boat and Yacht Council (ABYC) is a well-known organization in the marine industry, dedicated to providing safety for boaters worldwide. The ABYC develops voluntary global safety standards for the design, construction, maintenance, and repair of recreational boats. While “voluntary”, the ABYC standards are followed by most of the boating manufacturers, with an estimated 90% of the recreational boats on the water adhering to the ABYC standards. As a recognized leader in this area, recreational boat manufacturers and sellers that adhere to the ABYC standards have an advantage. Effectively, the ABYC serves as a building code for the boat building industry. The National Marine Manufacturers Association is the leading certification body for boats & yachts worldwide (NMMA). The “NMMA Certification” ensures a boat manufacturer is building per the standards set forth by the ABYC with the goal to improve reliability, safety, and quality. As such, in adhering to the ABYC standards, consumers recognize that those businesses in compliance with ABYC standards are providing boats that are designed, constructed, or repaired under the highest of safety criteria.

ABYC standards, for both gasoline and diesel applications, requires all fuel system components, including fuel filter assemblies, to pass a 2 ½ minute fire test (ANSI/UL 1105). Currently, gasoline filters that meet this requirement are typically equipped with a metal bowl. As such, filters with plastic clear sight bowls must be equipped with a metal heat shield in order to pass the fire test. The current systems in place suffer from several disadvantages. First, use of metal bowls make visual inspection difficult. Second, in use, the metal bowl is secured to the filter directly. Securing metal bowls to the filter unit requires the use of various securing tools. Finally, the use of metal bowls is not compatible with quick draining capabilities.

### SUMMARY OF THE INVENTION

Embodiments of the invention are directed towards systems, devices, and methods of providing fire protection and heat shielding of fuel filter bowls used in the marine industry. The fuel filter bowls hold gasoline or diesel fuel. The fire and protection system is designed to provide fire protection/heat shielding for filter clear bowls to pass the 2 ½ minute fire test as required by the ABYC standards. Embodiments of the fire and protection system comprise a backplate and a clear fuel filter bowl shield.

Accordingly, it is an objective of the invention to provide systems designed to provide fire protection of fuel filter bowls.

It is a further objective of the invention to provide devices designed to provide fire protection of fuel filter bowls.

It is yet another objective of the invention to provide methods of fire protection of fuel filter bowls.

It is an objective of the invention to provide systems designed to provide heat shielding of fuel filter bowls.

It is a further objective of the invention to provide devices designed to provide heat shielding of fuel filter bowls.

It is yet another objective of the invention to provide methods of heat shielding of fuel filter bowls.

It is a still further objective of the invention to provide systems that provide ABYC compliance related to marine vessel fuel system related components.

It is yet a further objective of the invention to provide devices that provide ABYC compliance related to marine vessel fuel system related components.

It is yet a further objective of the invention to provide methods that provide ABYC compliance related to marine vessel fuel system related components.

It is a still further objective of the invention to provide systems that provide ABYC compliance related to the use of clear fuel filter bowls in marine vessels.

It is yet a further objective of the invention to provide devices that provide ABYC compliance related to the use of clear fuel filter bowls in marine vessels.

It is yet a further objective of the invention to provide methods that provide ABYC compliance related to the use of clear fuel filter bowls in marine vessels.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a front perspective view of an illustrative embodiment of a system which provides fire protection and heat shielding of marine vessel clear fuel filter bowls, shown for use with diesel fuel engine;

FIG. 2 is a left side perspective view of the fire and protection system shown in FIG. 1;

FIG. 3 is a right side perspective view of the fire and protection system shown in FIG. 1;

FIG. 4 is a front perspective view of an illustrative embodiment of a system which provides fire protection and heat shielding of marine vessel clear fuel filter bowls, shown for use with a gasoline fuel engine;

FIG. 5 is a left side perspective view of the fire and protection system shown in FIG. 4;

FIG. 6 is a right side perspective view of the fire and protection system shown in FIG. 4;

FIG. 7 is a perspective view of an illustrative embodiment of a fire and protection system backplate;

FIG. 8 is a top view of the fire and protection system backplate illustrated in FIG. 7;

FIG. 9 is a bottom view of the fire and protection system backplate illustrated in FIG. 7;

FIG. 10 is a right side view of the fire and protection system backplate illustrated in FIG. 7;

FIG. 11 is a left side view of the fire and protection system backplate illustrated in FIG. 7;

FIG. 12 is a front view of the fire and protection system backplate illustrated in FIG. 7;

FIG. 13 is a rear view of the fire and protection system backplate illustrated in FIG. 7;

FIG. 14 is a perspective view of an illustrative embodiment of a fire and protection system backplate;

FIG. 15 is a top view of the fire and protection system backplate illustrated in FIG. 14;

FIG. 16 is a bottom view of the fire and protection system backplate illustrated in FIG. 14;

FIG. 17 is a right side view of the fire and protection system backplate illustrated in FIG. 14;

FIG. 18 is a left side view of the fire and protection system backplate illustrated in FIG. 14;

FIG. 19 is a front view of the fire and protection system backplate illustrated in FIG. 14;

FIG. 20 is a rear view of the fire and protection system backplate illustrated in FIG. 14;

FIG. 21 is a perspective view of an illustrative embodiment of a fire and protection system backplate;

FIG. 22 is a top view of the fire and protection system backplate illustrated in FIG. 21;

FIG. 23 is a bottom view of the fire and protection system backplate illustrated in FIG. 21;

FIG. 24 is a right side view of the fire and protection system backplate illustrated in FIG. 21;

FIG. 25 is a left side view of the fire and protection system backplate illustrated in FIG. 21;

FIG. 26 is a front view of the fire and protection system backplate illustrated in FIG. 21;

FIG. 27 is a rear view of the fire and protection system backplate illustrated in FIG. 21;

FIG. 28 is a perspective view of an illustrative embodiment of a fire and protection system backplate;

FIG. 29 is a top view of the fire and protection system backplate illustrated in FIG. 28;

FIG. 30 is a bottom view of the fire and protection system backplate illustrated in FIG. 28;

FIG. 31 is a right side view of the fire and protection system backplate illustrated in FIG. 28;

FIG. 32 is a left side view of the fire and protection system backplate illustrated in FIG. 28;

FIG. 33 is a front view of the fire and protection system backplate illustrated in FIG. 28;

FIG. 34 is a rear view of the fire and protection system backplate illustrated in FIG. 28;

FIG. 35 is a perspective view of an illustrative embodiment of a clear fuel filter bowl shield, shown with a bottom wall opening;

FIG. 36 is an alternative perspective view of the clear fuel filter bowl shield shown in FIG. 35;

FIG. 37 is an alternative perspective view of the clear fuel filter bowl shield shown in FIG. 35;

FIG. 38 is left side view of the clear fuel filter bowl shield shown in FIG. 35;

FIG. 39 is a right side view of the clear fuel filter bowl shield shown in FIG. 35;

FIG. 40 is a top view of the clear fuel filter bowl shield shown in FIG. 35;

FIG. 41 is a bottom view of the clear fuel filter bowl shield shown in FIG. 35;

FIG. 42 is a front view of the clear fuel filter bowl shield shown in FIG. 35;

FIG. 43 is a rear or back view of the clear fuel filter bowl shield shown in FIG. 35;

FIG. 44 is a perspective view of an illustrative embodiment of a clear fuel filter bowl shield, shown without a bottom wall opening;

FIG. 45 is an alternative perspective view of the clear fuel filter bowl shield shown in FIG. 44;

FIG. 46 is a left side view of the clear fuel filter bowl shield shown in FIG. 44;

FIG. 47 is a right side view of the clear fuel filter bowl shield shown in FIG. 44;

FIG. 48 is a bottom view of the clear fuel filter bowl shield shown in FIG. 44;

FIG. 49 is a top view of the clear fuel filter bowl shield shown in FIG. 44;

FIG. 50 is a perspective view of an illustrative embodiment of a clear fuel filter bowl shield cup;

FIG. 51 is an alternative perspective view of the clear fuel filter bowl shield cup shown in FIG. 50;

FIG. 52 is a side view of the clear fuel filter bowl shield cup shown in FIG. 50;

FIG. 53 is a top view of the clear fuel filter bowl shield cup shown in FIG. 50;

FIG. 54 is a bottom view of the clear fuel filter bowl shield cup shown in FIG. 50;

FIG. 55 is a perspective view of an alternative embodiment of the clear fuel filter bowl shield cup;

FIG. 56 is a side view of the clear fuel filter bowl shield cup shown in FIG. 55;

FIG. 57 is a perspective view of an illustrative embodiment of a fastening member;

FIG. 58 is an alternative perspective view of the fastening member shown in FIG. 57;

FIG. 59 is a perspective view of an illustrative embodiment of a fastening member;

FIG. 60 is an alternative perspective view of the fastening member shown in FIG. 59;

FIG. 61 is a perspective view of an illustrative embodiment of a grommet; and

FIG. 62 is an alternative perspective view of the grommet shown in FIG. 61.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

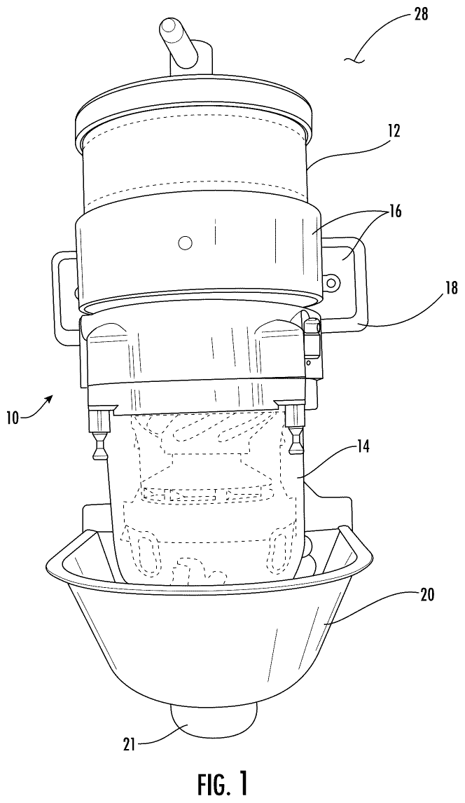

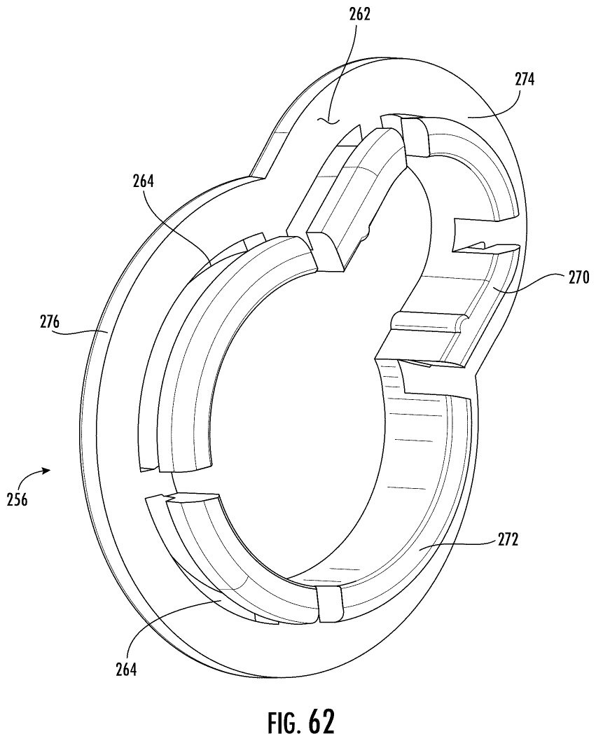

Referring to FIGS. 1-62, embodiments of the invention are directed towards systems, devices, and methods of providing fire protection for fuel filter bowls used in the marine industry; systems, devices, and methods of providing heat shielding of fuel filter bowls used in the marine industry; or systems, devices, and methods of providing fire protection and heat shielding of fuel filter bowls used in the marine industry. When in use, the systems, devices, and methods are designed to provide ABYC compliance relating to the use of filter bowls, particularly clear filter bowls.

Referring specifically to FIGS. 1-3, an embodiment of the system which provides fire protection and heat shielding of clear fuel filter bowls, referred to generally as a fire and protection system 10, is provided. The fire and protection system 10 is configured to allow for a fuel filter system to secure thereto; and for use with marine clear bowl fuel filters, such as RACOR Diesel Turbine Series assemblies or RACOR Gasoline assemblies. The fire and protection system 10 is designed to provide fire protection/heat shielding for filter clear bowls to pass the 2 ½ minute fire test as required by the ABYC standards.

For marine, diesel fuel filters, the fire and protection system 10 provides two key features: (1) provides tool-less removal, and (2) is compatible with clear bowl quick drains which enable fast, clean, safe, tool-less draining of contaminants or fuel to perform routine filter maintenance. For marine, gasoline fuel filters, the fire and protection system 10, (1) allows visual inspection of the fuel to check for any contamination including debris and/or water, and (2) is also compatible with the clear bowls having a quick drain that enables fast, clean, safe, tool-less draining of contaminants or fuel to perform routine filter element replacement.

The fire and protection system 10 shown in FIGS. 1-3 is engaged with a fuel filter system, such as a RACOR Diesel Turbine Series (500/900/1000), including a diesel-fuel and water separator unit 12, a clear fuel filter bowl 14, and an attachment bracket 16. The fire and protection system 10 comprises a backplate 18 and a clear fuel filter bowl shield 20, illustrated herein as a bowl shield. The backplate 18 and the clear fuel filter bowl shield 20 may be made of any material that provides for ABYC fire and heat compliance. In certain embodiments, the backplate 18 is made of stainless steel. In certain embodiments, the clear fuel filter bowl shield 20 is made of a stainless steel. In certain embodiments, the clear fuel filter bowl shield 20 may include a bowl cup 21. One or more fastening members, such as a bracket screw 22, a backplate screw 24, and a clear fuel filter bowl shield screw 26 may be used as mechanical devices to secure one or more components.

As provided in FIGS. 1-3, the fire and protection system 10 is shown with the backplate 18 secured to a surface or wall 28, which could represent any boat surface or wall. In use, the backplate 18 is secured to the surface or wall 28 via backplate screws 24. Once secure, the gasoline and water separator unit 12 may be secured to the backplate 18 by securing the attachment bracket 16 to the backplate 18 via bracket screws 22. The clear fuel filter bowl shield 20 is designed to be removably attached/secured to the backplate 18 via one or more clear fuel filter bowl shield screws 26.

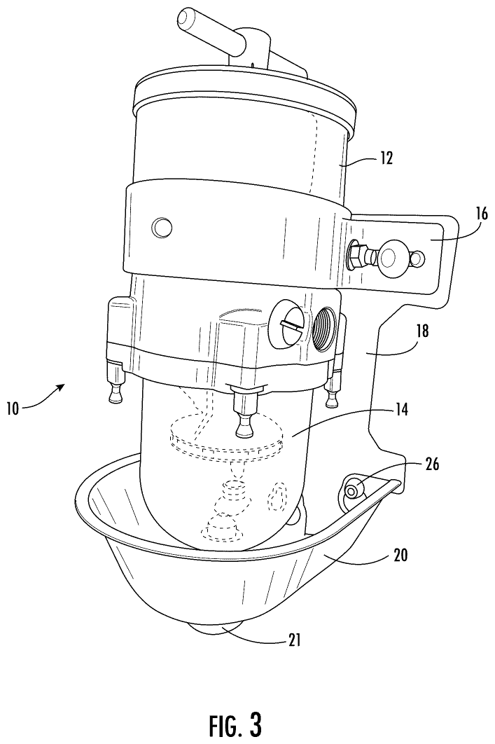

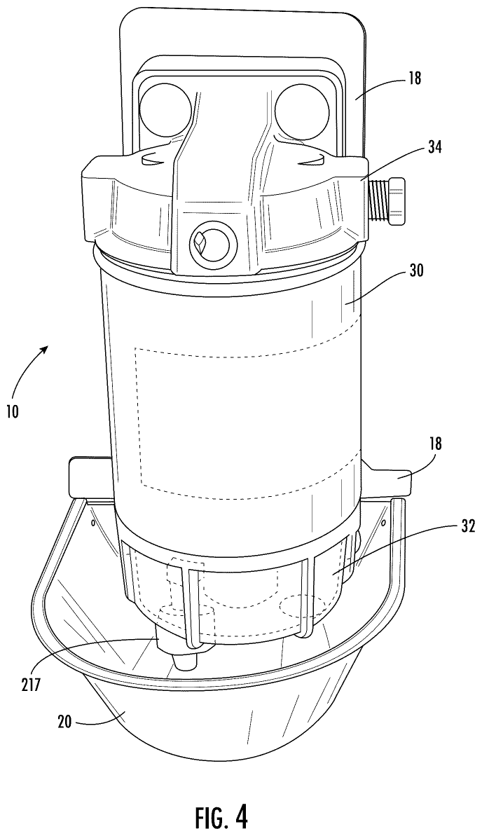

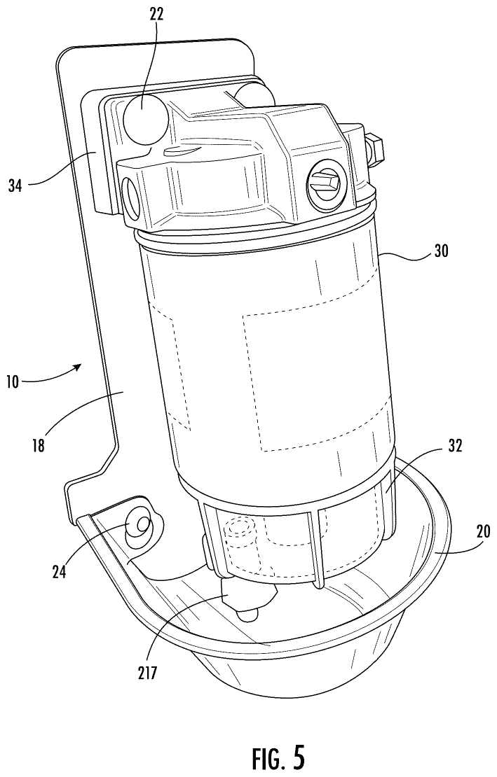

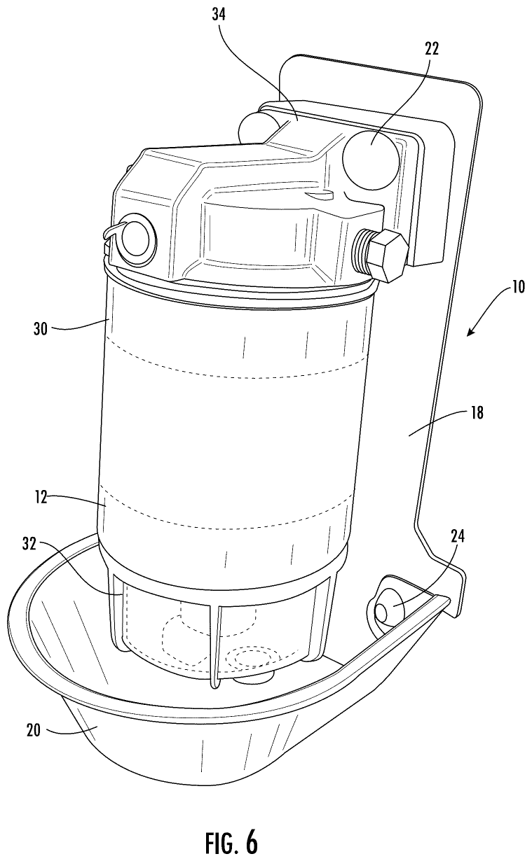

Referring to FIGS. 4-6, an embodiment of the fire and protection system 10 is shown engaged with a gasoline fuel filter system, such as a RACOR gasoline spin-on series assembly, (RAC 320R-RAC-01 or 660R-RAC-01), including a gasoline fuel and water separator unit 30, a clear fuel filter bowl 32, and an attachment bracket 34. The fire and protection system 10, using the same structural components of a backplate 18, a clear fuel filter bowl shield 20, and fasteners (22, 24, 26), functions in the same manner as described for use with the diesel-fuel and water separator unit 12, clear fuel filter bowl 14, and attachment bracket 16. While having the same functions, different designs (to be described below) for the backplate 18 and/or the clear fuel filter bowl shield 20 may be used in either case. The size and shape of the structures used is dependent on the type of filter system and/or filter bowl used.

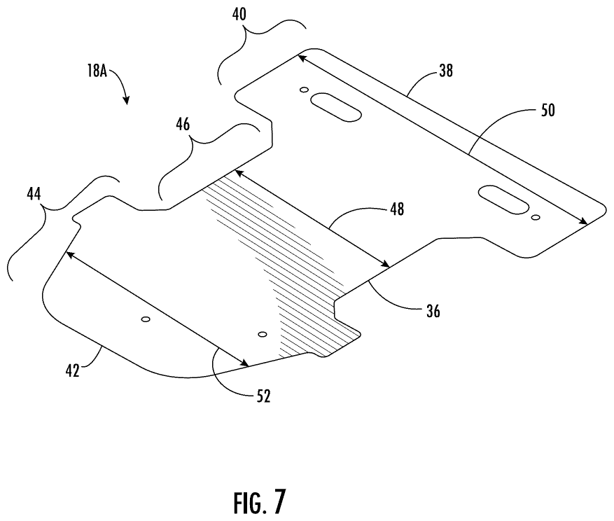

Referring to FIGS. 7-13, an illustrative embodiment of the backplate 18, referred to specifically as backplate 18A (the embodiment shown in FIGS. 1-3), is provided. The backplate 18A comprises a body 36 having a first end 38 (may be defined as an upper end for the area where the attachment bracket 16 secures thereto) defining an attachment bracket engagement section 40, a second, opposing end 42 (may be defined as a lower end for the area where the clear fuel filter bowl shield 20 secures thereto), defining a clear fuel filter bowl shield engagement section 44, and an intermediate section 46; the intermediate section 46 bridging or connecting the attachment bracket engagement section 40 and the clear fuel filter bowl shield engagement section 44. The intermediate section 46 may have a width 48 which is smaller than the width 50 of the attachment bracket engagement section 40 or the width 52 of the clear fuel filter bowl shield engagement section 44.

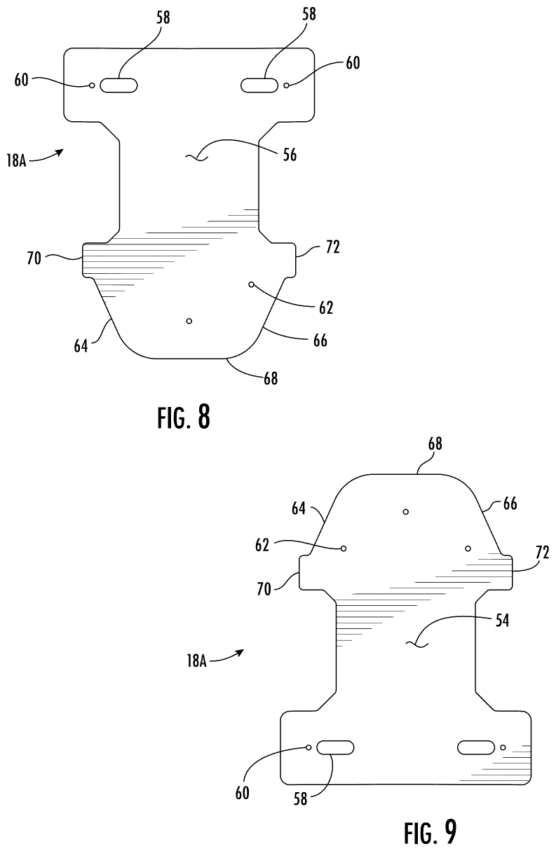

In use, a back surface 54 (see FIG. 9) engages or contacts a surface the backplate 18A attaches or secures to. The attachment bracket 16 and the clear fuel filter bowl shield 20 secures or attaches to a front surface 56 (see FIG. 8) of the backplate 18A. Within the attachment bracket engagement section 40 are a plurality of openings, including elongated, oval shaped openings 58 and smaller, circular shaped openings 60. Each elongated, oval shaped opening 58 is sized and shaped to receive a backplate screw 24. Each circular shaped opening 60 is sized and shaped to receive a bracket screw 22. The clear fuel filter bowl shield engagement section 44 also includes a plurality of similarly sized and shaped, and spaced apart openings 62. Each opening 62 is sized and shaped to receive a clear fuel filter bowl shield screw 26.

The clear fuel filter bowl shield engagement section 44 is designed to allow the clear fuel filter bowl shield 20 to be secured within. In certain embodiments, the front section may include tapered walls 64 and 66, terminating in a rounded and flat ended edge 68. The clear fuel filter bowl shield engagement section 44 may also include tabs 70 and 72.

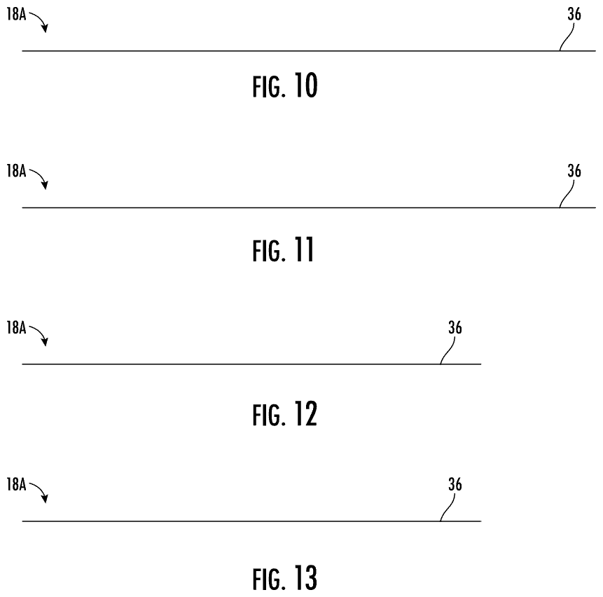

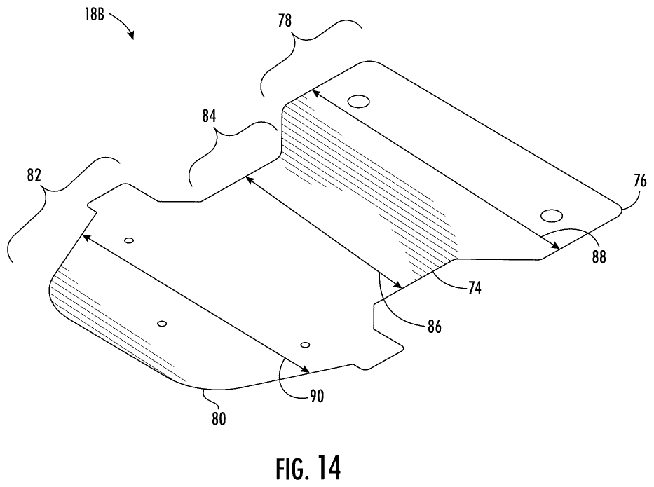

Referring to FIGS. 14-20, an illustrative embodiment of the backplate 18, referred to specifically as backplate 18B, is provided. The backplate 18B comprises a body 74 having a first end 76 (may be defined as an upper end for the area where the attachment bracket 16 secures thereto) defining an attachment bracket engagement section 78, a second, opposing end 80 (may be defined as a lower end for the area where the clear fuel filter bowl shield 20 secures thereto), defining a clear fuel filter bowl shield engagement section 82, and an intermediate section 84; the intermediate section 84 bridging or connecting the attachment bracket engagement section 78 and the clear fuel filter bowl shield engagement section 82. The intermediate section 84 may have a width 86 which is smaller than the width 88 of the attachment bracket engagement section 78 or the width 90 of the clear fuel filter bowl shield engagement section 82.

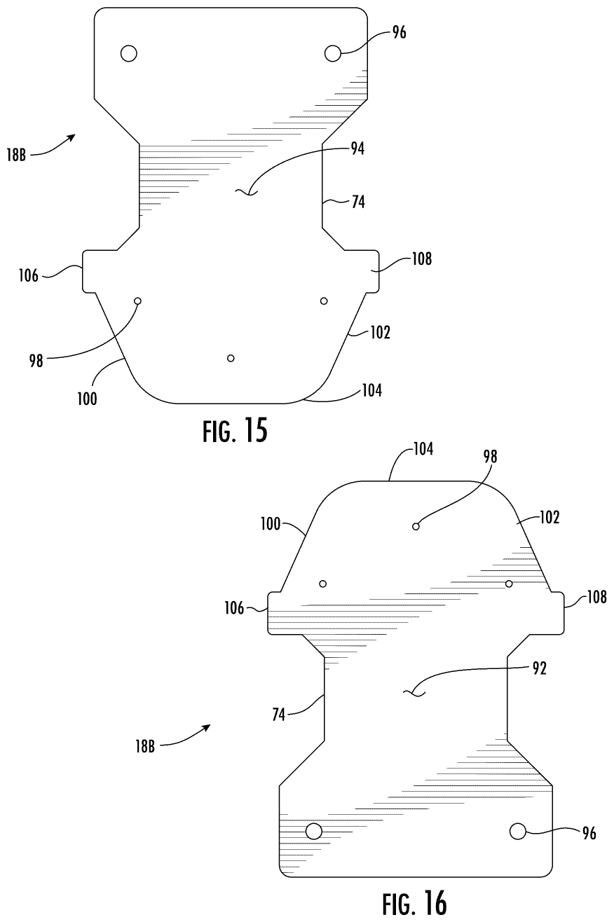

In use, a back surface 92 (see FIG. 16) engages or contacts a surface the backplate 18B attaches or secures to. The attachment bracket 16 and the clear fuel filter bowl shield 20 secures or attaches to a front surface 94 (see FIG. 15) of the backplate 18B. Within the attachment bracket engagement section 78 are a plurality of openings 96, which are sized and shaped to receive backplate screws 24. The clear fuel filter bowl shield engagement section 82 also includes a plurality of similarly sized and shaped, and spaced apart openings 98. Each opening 98 is sized and shaped to receive a clear fuel filter bowl shield screw 26.

The clear fuel filter bowl shield engagement section 82 is designed to allow the clear fuel filter bowl shield 20 to be secured within. In certain embodiments, the front section may include tapered walls 100 and 102, terminating in a rounded and flat ended edge 104. The clear fuel filter bowl shield engagement section 82 may also include tabs 106 and 108.

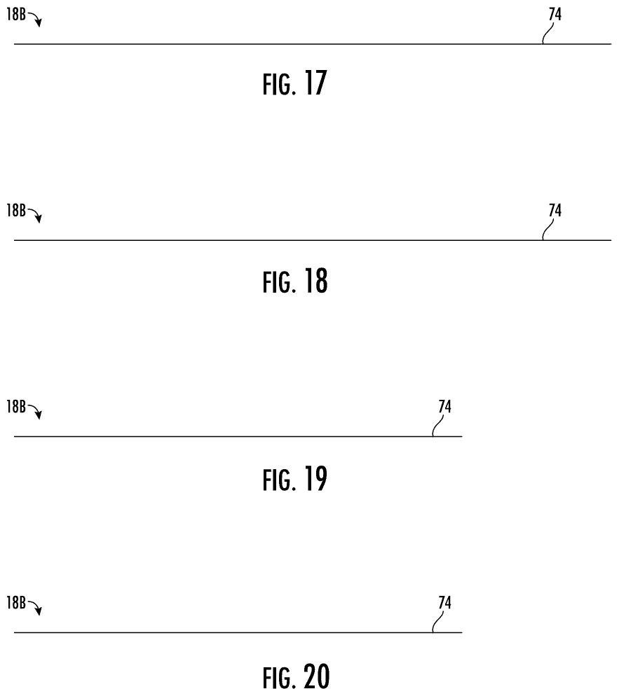

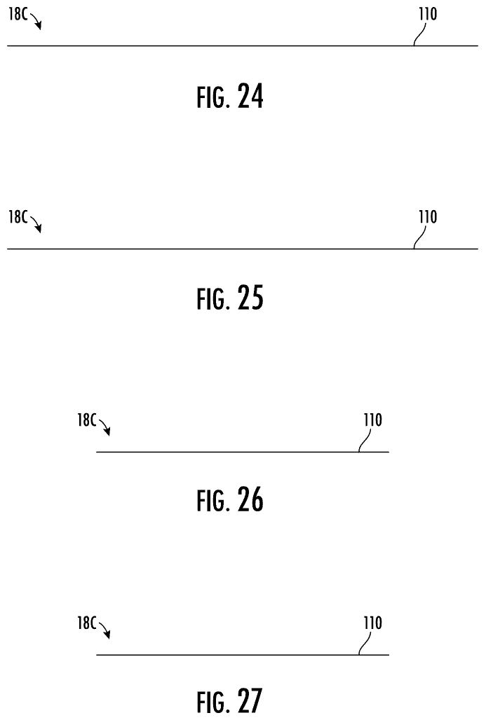

Referring to FIGS. 21-27, an illustrative embodiment of the backplate 18, referred to specifically as backplate 18C, is provided. The backplate 18C comprises a body 110 having a first end 112 (may be defined as an upper end for the area where the attachment bracket 16 secures thereto) defining an attachment bracket engagement section 114, a second, opposing end 116 (may be defined as a lower end for the area where the clear fuel filter bowl shield 20 secures thereto), defining a clear fuel filter bowl shield engagement section 118, and an intermediate section 120; the intermediate section 120 bridging or connecting the attachment bracket engagement section 114 and the clear fuel filter bowl shield engagement section 118. The intermediate section 120 may have a width 122 which is the same as the width 124 of the attachment bracket engagement section 114 and is smaller than the width 126 of the clear fuel filter bowl shield engagement section 118.

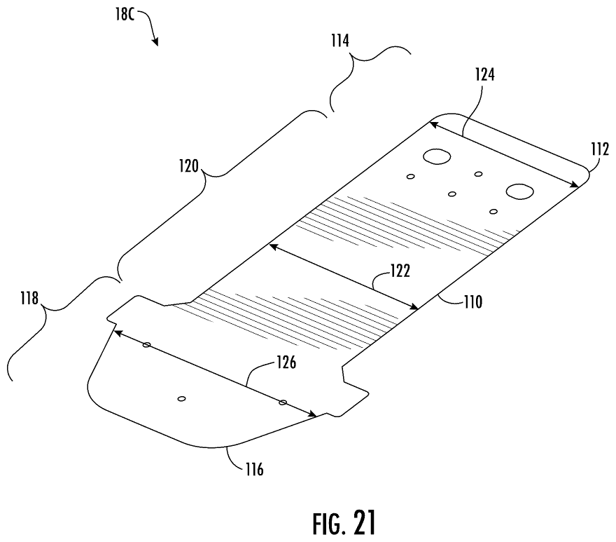

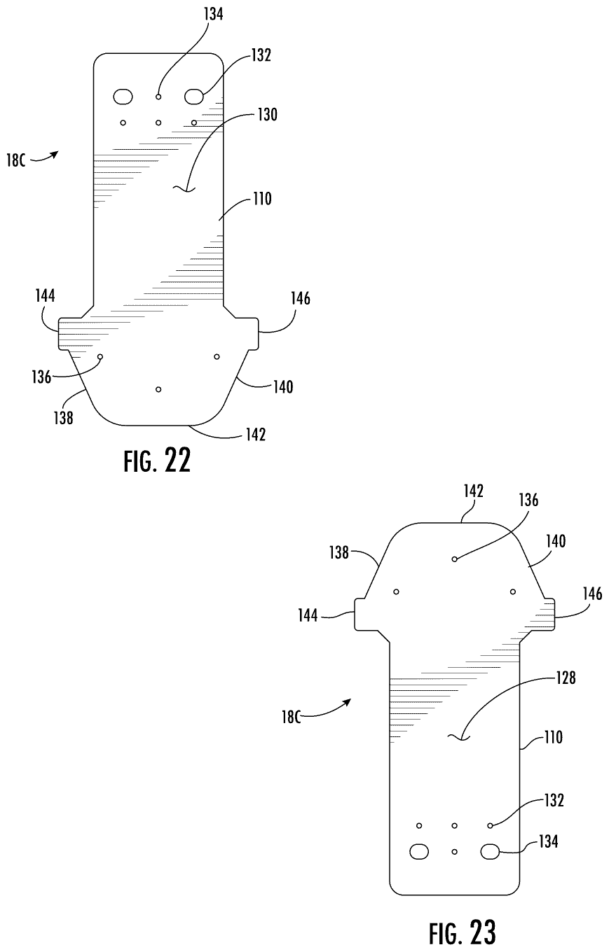

In use, a back surface 128 (see FIG. 23) engages or contacts a surface the backplate 18C attaches or secures to. The attachment bracket 16 and the clear fuel filter bowl shield 20 secures or attaches to a front surface 130 (see FIG. 22) of the backplate 18C. Within the attachment bracket engagement section 114 are a plurality of openings, including elongated, oval shaped openings 132 and smaller, circular shaped openings 134. Each elongated, oval shaped opening 132 is sized and shaped to receive a backplate screw 24. Each circular shaped opening 134 is sized and shaped to receive a bracket screw 22. The clear fuel filter bowl shield engagement section 118 also includes a plurality of similarly sized and shaped, and spaced apart openings 136. Each opening 136 is sized and shaped to receive a clear fuel filter bowl shield screw 26.

The clear fuel filter bowl shield engagement section 118 is designed to allow the clear fuel filter bowl shield 20 to be secured within. In certain embodiments, the front section may include tapered walls 138 and 140, terminating in a rounded and flat ended edge 142. The clear fuel filter bowl shield engagement section 118 may also include tabs 144 and 146.

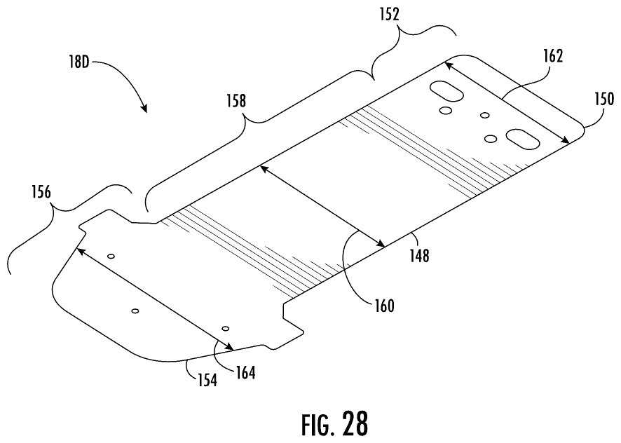

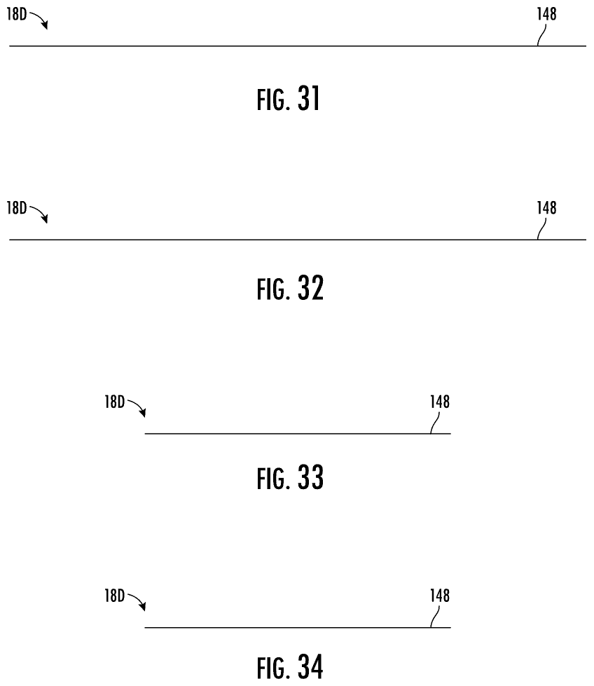

Referring to FIGS. 28-34, an illustrative embodiment of the backplate 18, referred to specifically as backplate 18D, is provided. The backplate 18D comprises a body 148 having a first end 150 (may be defined as an upper end for the area where the attachment bracket 16 secures thereto) defining an attachment bracket engagement section 152, a second, opposing end 154 (may be defined as a lower end for the area where the clear fuel filter bowl shield 20 secures thereto), defining a clear fuel filter bowl shield engagement section 156, and an intermediate section 158; the intermediate section 158 bridging or connecting the attachment bracket engagement section 152 and the clear fuel filter bowl shield engagement section 156. The intermediate section 158 may have a width 160 which is the same as the width 162 of the attachment bracket engagement section 152 and is smaller than the width 164 of the clear fuel filter bowl shield engagement section 156.

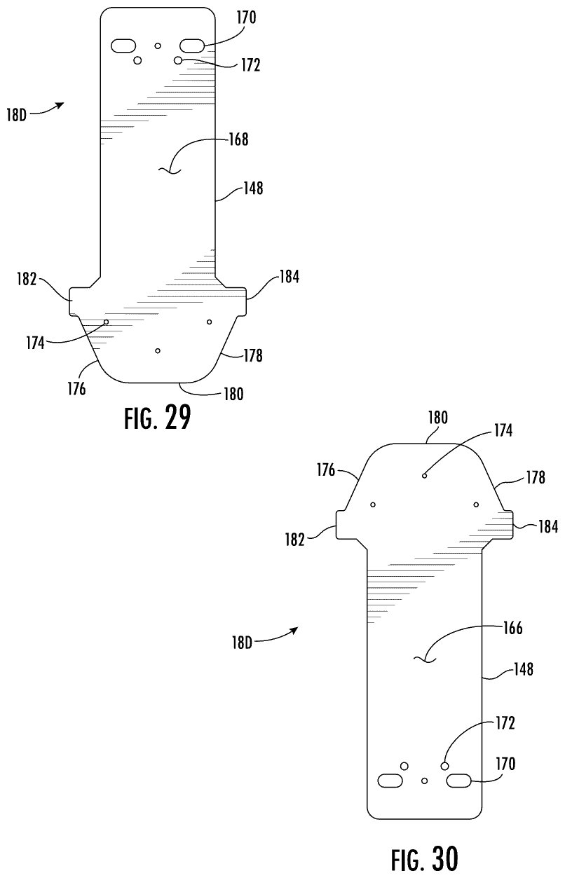

In use, a back surface 166 (see FIG. 30) engages or contacts a surface the backplate 18D attaches or secures to. The attachment bracket 16 and the clear fuel filter bowl shield 20 secures or attaches to a front surface 168 (see FIG. 29) of the backplate 18D. Within the attachment bracket engagement section 152 are a plurality of openings, including elongated, oval shaped openings 170 and smaller, circular shaped openings 172. Each elongated, oval shaped opening 170 is sized and shaped to receive a backplate screw 24. Each circular shaped opening 172 is sized and shaped to receive a bracket screw 22. The clear fuel filter bowl shield engagement section 156 also includes a plurality of similarly sized and shaped, and spaced apart openings 174. Each opening 174 is sized and shaped to receive a clear fuel filter bowl shield screw 26.

The clear fuel filter bowl shield engagement section 156 is designed to allow the clear fuel filter bowl shield 20 to be secured within. In certain embodiments, the front section may include tapered walls 176 and 178, terminating in a rounded and flat ended edge 180. The clear fuel filter bowl shield engagement section 156 may also include tabs 182 and 184.

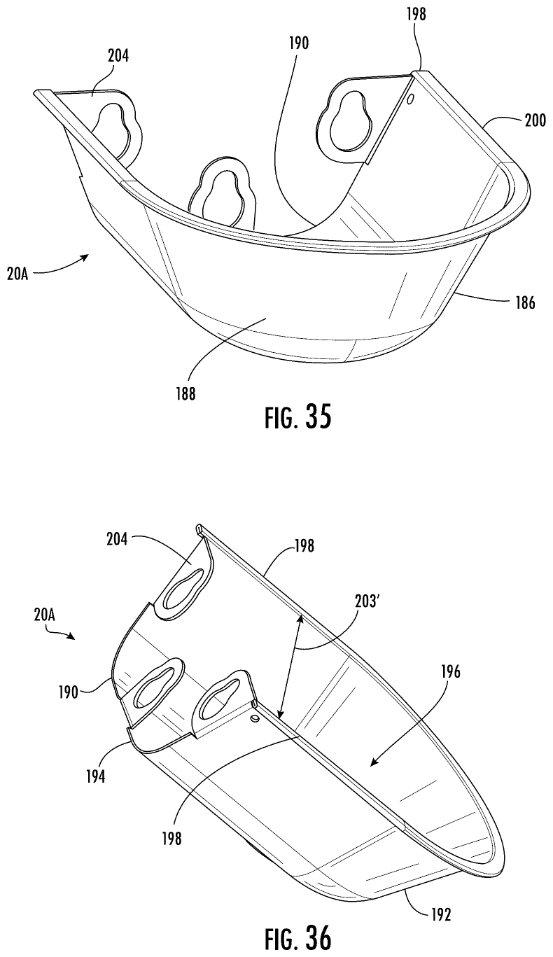

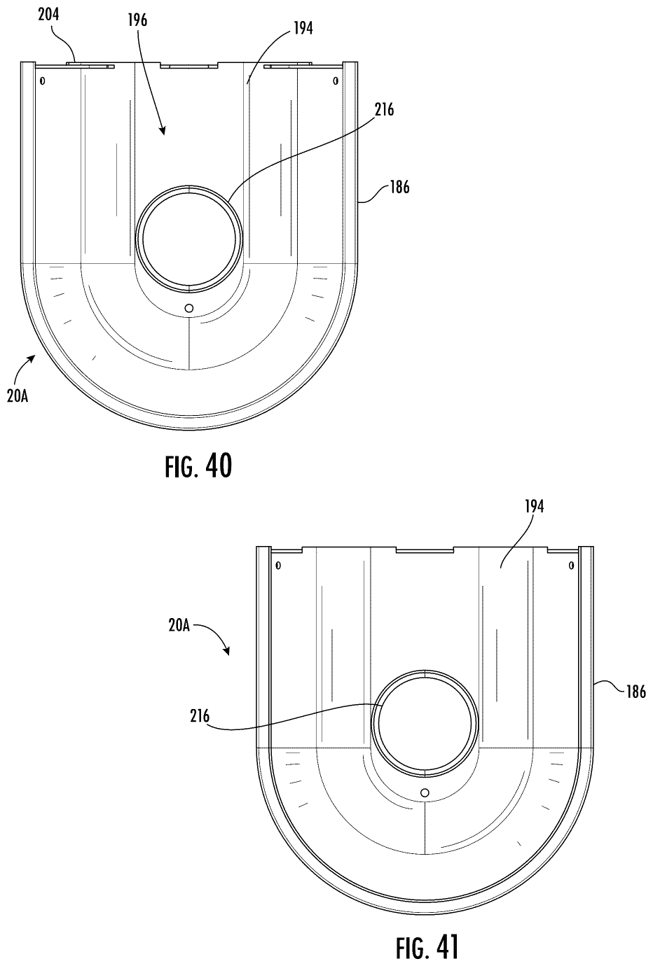

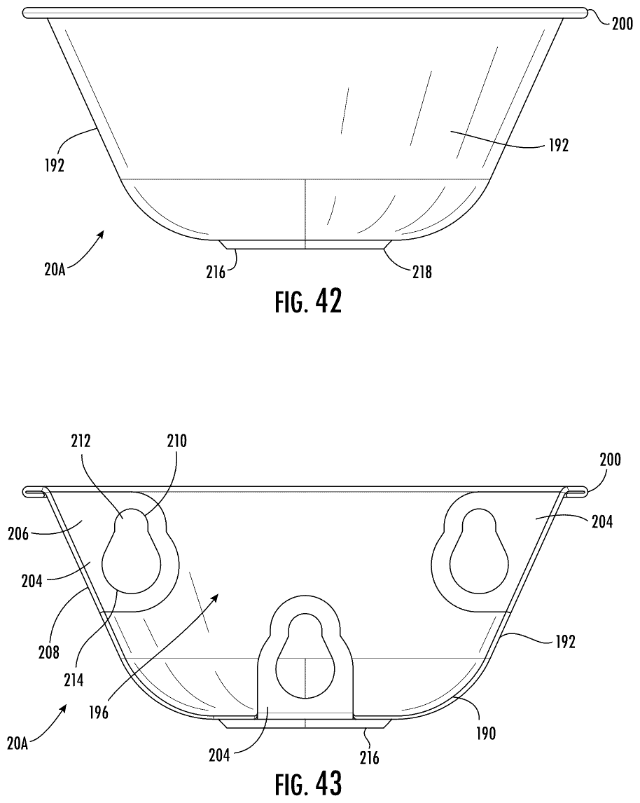

Referring to FIGS. 35-43, an illustrative embodiment of the clear fuel filter bowl shield 20, referred to specifically as clear fuel filter bowl shield 20A, is provided. The clear fuel filter bowl shield 20A comprises a body 186 having a first end 188 (may be defined as a front end, i.e. away from the surface for which clear fuel filter bowl shield 20A attaches to), and a second, opposing end 190 (may be defined as a back end, i.e., the area where the clear fuel filter bowl shield 20A secures thereto). The body 186 may be defined as a continuous wall or surface 192 that extends around a bottom wall or surface 194, ending at the second end 190, thus framing an interior 196 (partially enclosed interior as there is no top wall or surface to completely enclose the interior). The second end 190 is open, as the continuous wall or surface 192 does not extend all the way around the bottom wall or surface 194 at that area. An upper edge 198 may include a ridge or ledge 200 that extends out away from the interior 196.

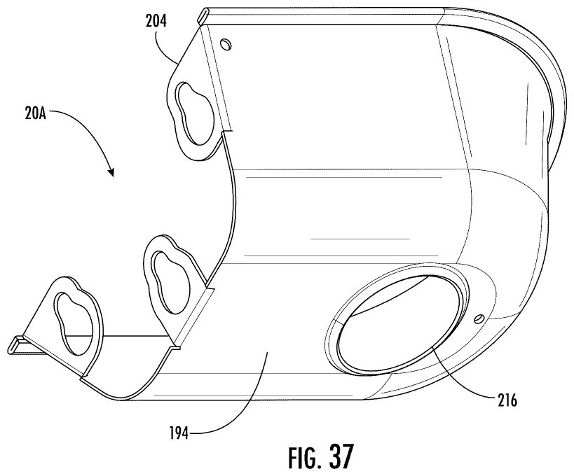

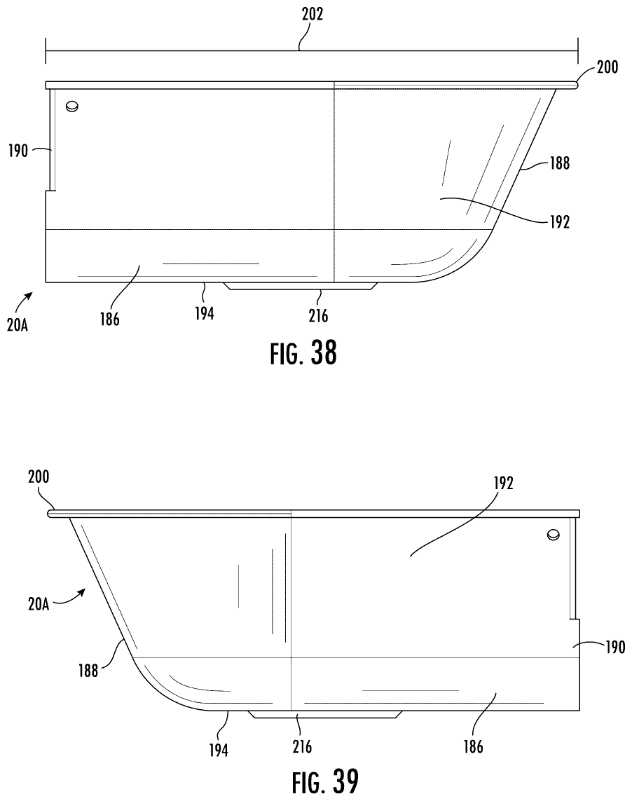

The length 202 (see FIG. 38) of the body 186, i.e. the distance from the first end 188 to the second, opposing end 190 and the distance 203 between opposing edges 198 (see FIG. 36) should be of sufficient length and distance so that when the clear fuel filter bowl shield 20 is attached to the backplate 18, the body 186 extends out past and around the clear fuel filter bowl 14/32.

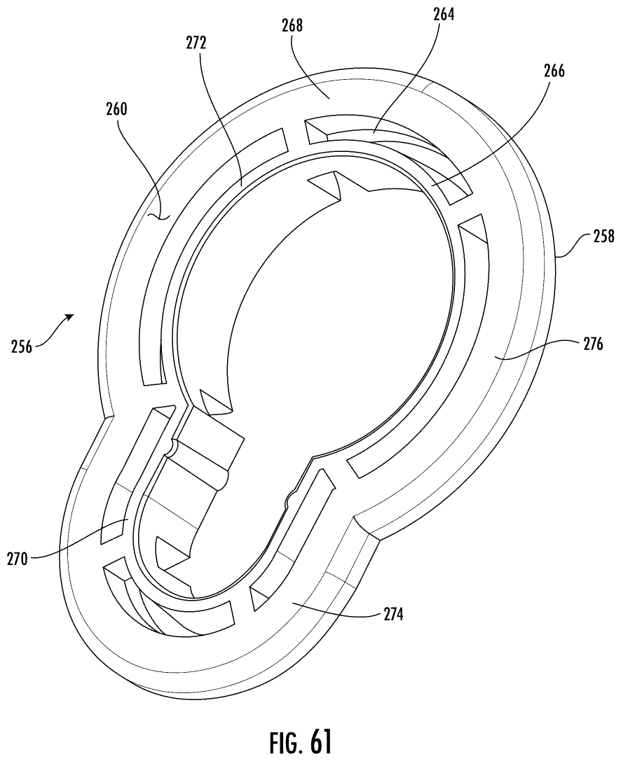

The second end 190 includes a plurality of backplate engaging members 204. The backplate engaging members 204 are constructed and arranged to provide a mechanism for removably attaching and securing the clear fuel filter bowl shield 20 to the backplate 18. Once attached and secured, the backplate engaging members 204 help maintain the clear fuel filter bowl shield 20 in place and properly positioned. Embodiments of the backplate engaging members 204 illustrated comprise a tab or plate 206 integrally formed from or secured to an edge 208. The tab or plate 206 is positioned, either in a vertical orientation or a horizontal orientation, to extend upwardly or inwardly, i.e. towards the interior 196. The tab or plate 206 includes a locking member 210 designed to engage with the clear fuel filter bowl shield screws 26. The locking member 210 includes pear-shaped keyhole design, having a first portion 212 and a second portion 214, where the first portion 212 has a smaller or narrower profile than the second portion 214. This configuration allows a user to easily secure and remove (by moving the backplate engaging members 204 up/down to lock/unlock once placed on or over the clear fuel filter bowl shield screws 26) the clear fuel filter bowl shield 20A to/from the backplate 18 without the use of tools. To help reinforce the connection, a grommet 256 (see FIGS. 61 and 62) may be inserted within the backplate engaging members 204.

To be compatible with the clear bowls having a quick drain that enables fast, clean, safe, tool-less draining of contaminants or fuel to perform routine filter element replacement, the bottom wall or surface 194 may comprise an opening 216, optionally with a lip or ridge 218 extending outwardly, away from the interior 196. As shown, the opening 216 is centrally positioned. However, in alternative embodiments opening 216 is positioned off-center.

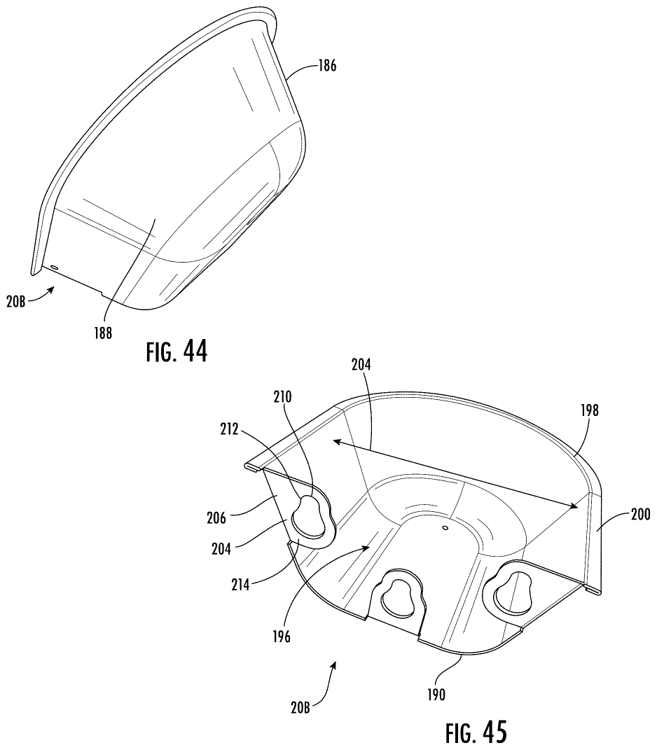

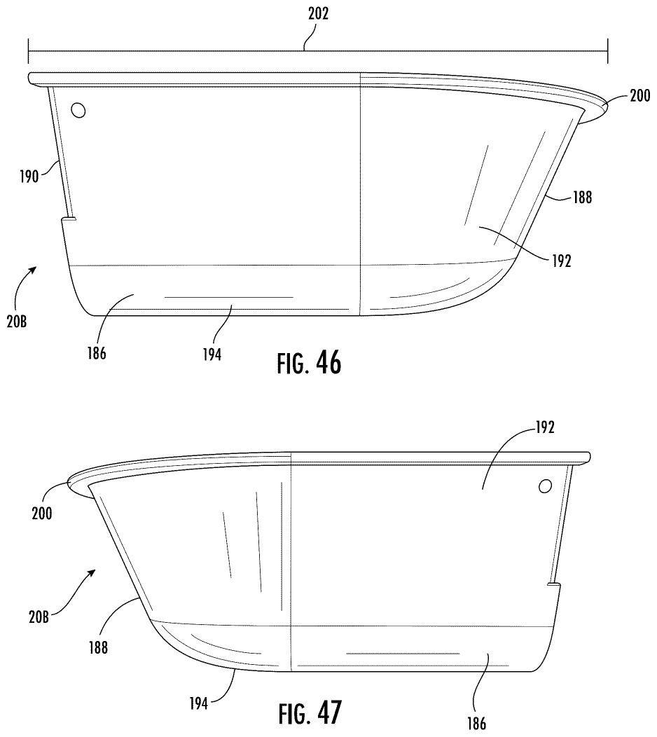

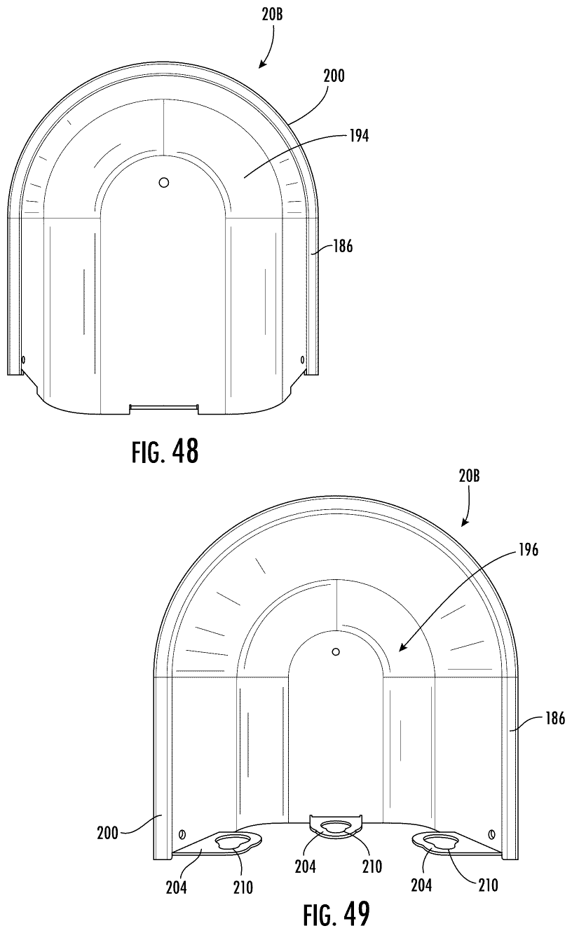

Referring to FIGS. 44-49, an illustrative embodiment of the clear fuel filter bowl shield 20, referred to specifically as clear fuel filter bowl shield 20B, is provided. The clear fuel filter bowl shield 20B has the same features and structures (like reference numbers representing like structures) as that described for the clear fuel filter bowl shield 20A, differing only in that the bottom wall or surface 194 does not include an opening 216.

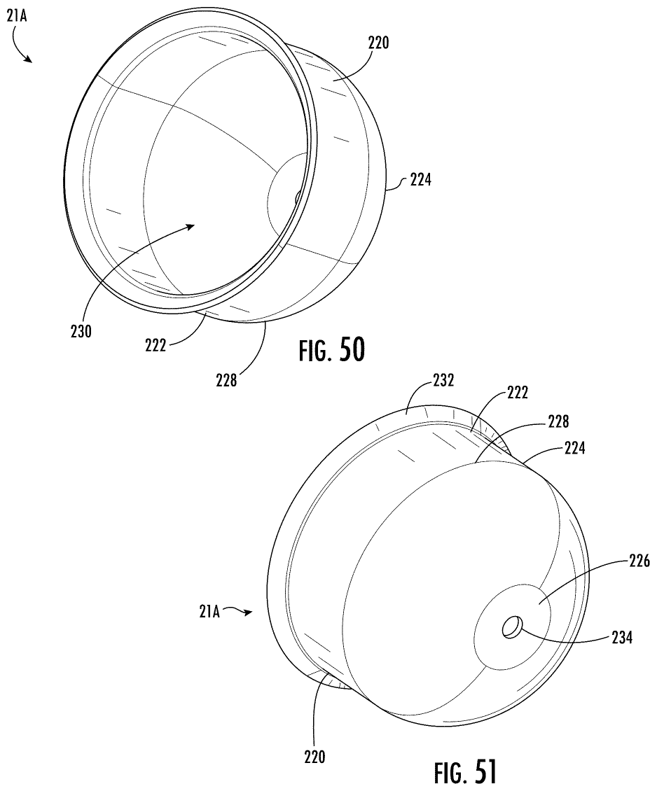

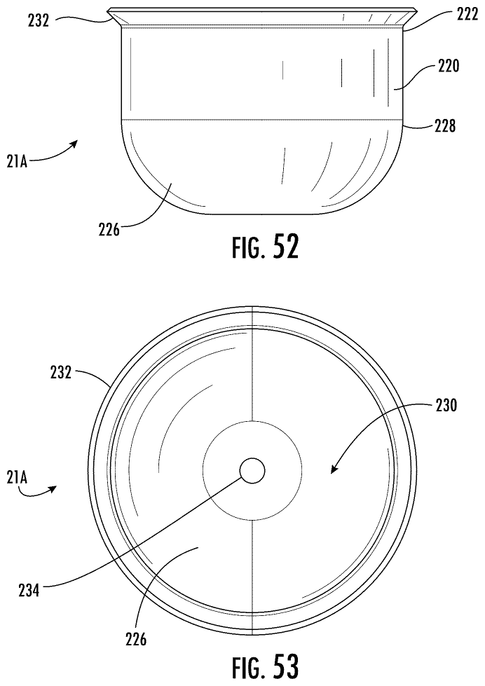

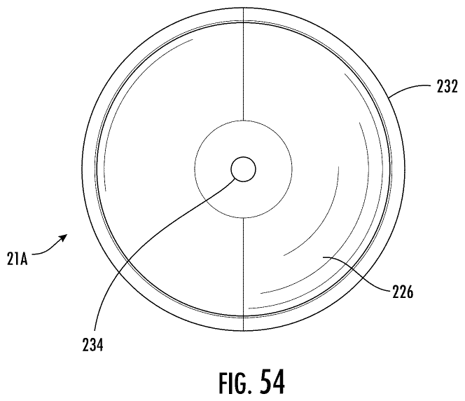

Referring to FIGS. 50-54, an illustrative embodiment of the clear fuel filter bowl shield cup 21, referred to specifically as clear fuel filter bowl shield cup 21A, is provided. The clear fuel filter bowl shield cup 21A comprises a body 220 having a first end 222, a second opposing end 224, and a bottom wall or surface 226. A continuous wall or surface 228 partially (upper end is open) encloses the bottom wall or surface 226 to form an interior 230. The first end 222 includes a ridge or lip 232. The bottom surface 226 may include an opening 234 for drainage.

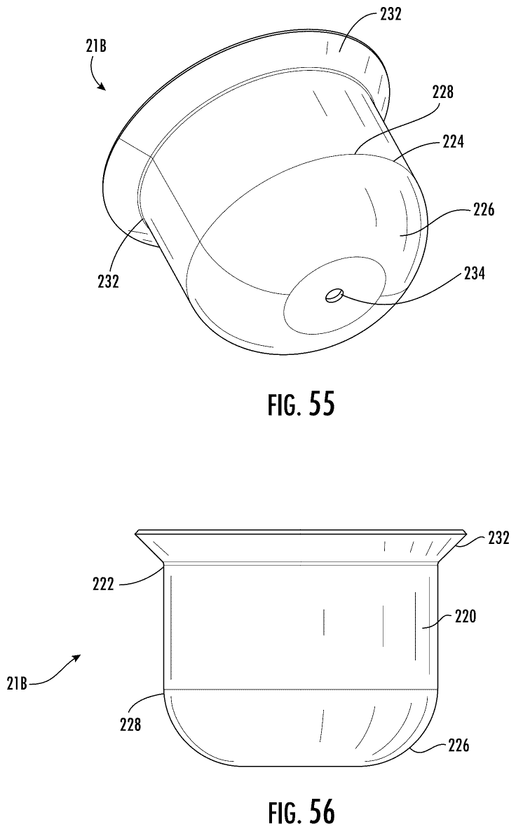

Referring to FIGS. 55-56, an illustrative embodiment of the clear fuel filter bowl shield cup 21, referred to specifically as clear fuel filter bowl shield cup 21B, is provided. The clear fuel filter bowl shield cup 21B has the same features and structures (like reference numbers representing like structures) as that described for clear fuel filter bowl shield cup 21A, differing only in that the ridge or lip 232 is bigger and more angled.

The clear fuel filter bowl shield cup 21, the whether the embodiment described as 21A or 21B, fits and/or rests within the bottom wall or surface opening 216. When placed within, the clear fuel filter bowl shield cup body 220 extends outwardly, away from the clear fuel filter bowl shield body bottom wall or surface 194, see for example FIGS. 1-3. The diameter of the clear fuel filter bowl shield cup 21 may be smaller than the opening 216, with the ridge or lip 232 being of sufficient size and length to keep the clear fuel filter bowl shield cup 21 in place, i.e., not falling through opening 216. The size of the clear fuel filter bowl shield cup body 220 may be sufficient to cover a fuel filter bowl quick drain (217, FIG. 4 or FIG. 5) or any other drainage component of the fuel filter bowl when in use.

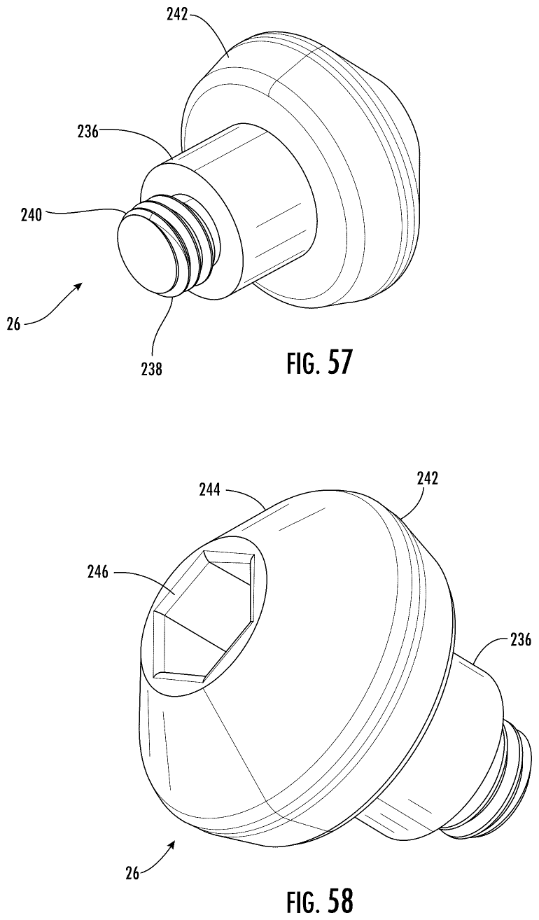

Referring to FIGS. 57 and 58, an embodiment of the clear fuel filter bowl shield screw 26 is illustrated. The clear fuel filter bowl shield screw 26 comprises a body 236 having a lower section 238 comprising a threaded member 240 and an upper section 242 comprising a frustoconical shaped head 244 having a polygonal (hexagonal) shaped opening 246.

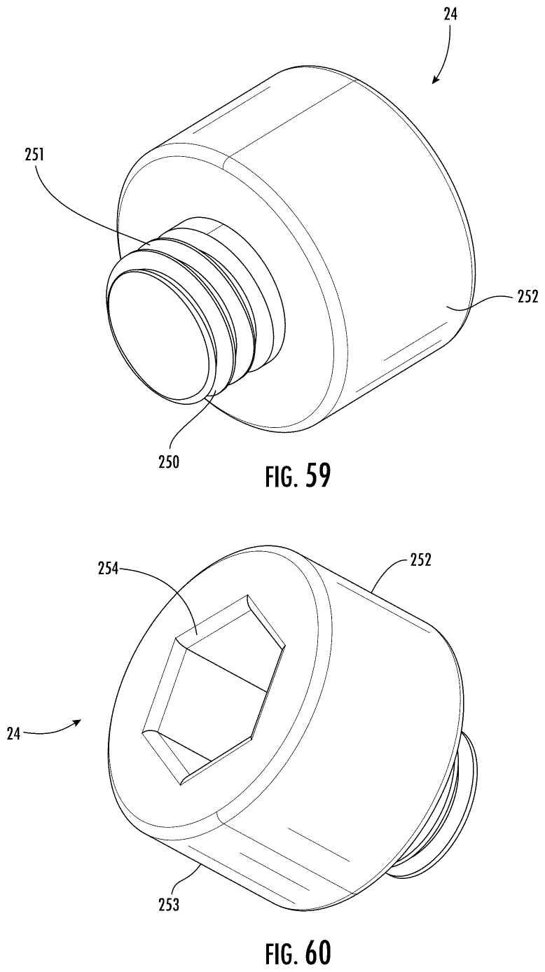

Referring to FIGS. 59 and 60, an embodiment of fastening member 24 is illustrated. The fastening member 24 comprises a lower member 250 comprising a threaded member 251, and an upper member 252 comprising a round or cylindrical shaped head 253 having a polygonal (hexagonal) shaped opening 254.

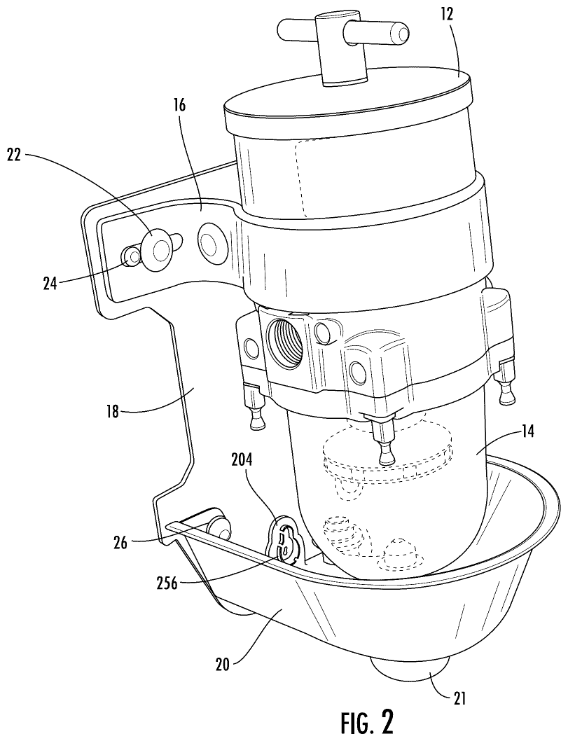

Referring to FIGS. 61 and 62, an embodiment of a grommet 256 is illustrated. The grommet 256 comprises a body 258 having a first (or top) surface 260 and a second, opposing (or bottom) surface 262. The grommet 256 may include one or more cut-out sections 264, forming an inner member body 266 and an outer member body 268. The inner member body 266 comprises a pear-shaped keyhole design, having a first portion 270 and a second portion 272, where the first portion 270 has a smaller or narrower profile than the second portion 272. The outer member body 268 comprises a pear-shaped keyhole design, having a first portion 274 and a second portion 276, where the first portion 274 has a smaller or narrower profile than the second portion 276. Grommet 256 is designed to mirror the shape of the locking member 210 and be inserted and fit within, see FIG. 2

Testing: ABYC standards for inboard fuel filter installations for gasoline or diesel engines: two and one-half minute heat test.

A representative sample of a fuel/water separator with an embodiment of the fire and protection system 10 was fire tested.

The fire and protection system 10 was subjected to a 2 ½-minute fire test in accordance with the current SAE J1527:2022 Standard and USCG Test Procedures to determine compliance with SAE J1527 and the USCG requirements for fire resistance.

The procedures used to accomplish the tests are the SAE J1527:2022 and the IMANNA Test Procedure P-FUEL-Fuel System Component Fire Test Procedure along with the USCG Fuel Systems Standard Test Procedure, specifically the 2 ½-minute fire test and hydrostatic pressure test.

The fire and protection system 10 was subjected to a 2 ½-minute fire test in a vented fire chamber followed by a hydrostatic pressure test. The fire and protection system 10 was filled with gasoline throughout the fire test period. Temperature measurements were recorded within an inch of the fire and protection system 10 during the burn period. Following the burn period, the fire was extinguished, and the fire and protection system 10 was cooled to ambient. After the fire and protection system 10 cooled, the hydrostatic pressure fuel leakage test was performed at a pressure of 36 inches of head (approximately 1 PSIG).

Results: The fire and protection system 10 was installed in a chamber and subjected to a 2 ½-minute fire test in which the temperature reached a minimum of 650° C. at a point within 1 inch of the OUT body during the burn period. Following the 2 ½-minute fire test, the fire and protection system 10 remained intact and did not leak fuel. The pressure test confirmed no fuel leakage from the fire and protection system 10. Following the 2 ½-minute fire test, a hydrostatic pressure test was performed by opening the fuel valve attached to the chamber and allowing fuel to flow though the fire and protection system 10. As soon as a steady flow was achieved, the valve was closed and the fire and protection system 10 was subjected to the hydrostatic pressure testing corresponding to a 36-inch head of fuel, approximately 1 psi. No leakage was detected on the fire and protection system 10 when filled with gasoline throughout and following the fire test period.

The results of the tests performed indicated that the fire and protection system 10 as received and tested meet the fire resistance requirements for fuel system components required by the USCG, as stated in CFR 183.590, as well as the SAE J1527:2022 Standard when filled with fuel throughout the test.

All equipment used in the performance of the tests were calibrated to standards traceable to the N.I.S.T and/or verified at the time of the test using internationally recognized methods to validate the accuracy and repeatability of the values recorded or collected during the tests.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for protecting a marine vessel fuel filter bowl from fire and heat, comprising:
a filter bowl shield constructed and arranged to prevent or minimize damage to a marine vessel fuel filter bowl from fire or heat; and
a support plate constructed and arranged for securing said filter bowl shield thereto and supporting said.

2. The system according to claim 1, wherein said filter bowl secures to or is removed from said support plate removal without the use of tools.

3. The system according to claim 1, wherein said support plate comprises:
a first end defining a first attachment section sized and shaped to secure a marine fuel filter system bracket;
a second, opposing end, said second opposing end defining a second attachment section sized and shaped to secure said filter bowl shield thereto; and
an intermediate section bridging said first end and said second end attachment bracket engagement section and the fuel filter bowl shield engagement section.

4. The system according to claim 3, wherein,
said support plate first end comprises one or more openings sized and shaped to receive a one or more first securing member; and
said support plate second end comprises one or more openings sized and shaped to receive one or more second securing members.

5. The system according to claim 1, wherein said filter bowl shield comprises:
a body having a first end and a second, opposing end, said body defined by continuous wall or surface extending directionally from a bottom wall or surface and ending at said second end, thus providing a partially enclosed and open interior.

6. The system according to claim 1, wherein said filter bowl shield body comprises an upper edge.

7. The system according to claim 6, wherein said upper edge ledge extends away from the said interior.

8. The system according to claim 5, wherein said filter bowl shield body has a length of sufficient wherein, when said filter bowl shield is attached to said support plate protecting a fuel filter bowl, said filter bowl shield body extends out past and around said clear fuel filter bowl.

9. The system according to claim 5, wherein said filter bowl shield body has a sufficient length wherein, when said filter bowl shield is attached to said support plate and protecting a fuel filter bowl, said filter bowl shield body extends out past and around said clear fuel filter bowl.

10. The system according to claim 5, wherein said filter bowl shield body has a distance between opposing edges of sufficient length wherein, when said filter bowl shield is attached to said support plate and protecting a fuel filter bowl, said filter bowl shield body extends out past and around said clear fuel filter bowl.

11. The system according to claim 5, wherein said filter bowl shield body second end comprises at least one a support plate engaging member constructed and arranged to removably attach and secure said fuel filter bowl shield to said support plate.

12. The system according to claim 11, wherein said at least one a support plate engaging member comprises a locking member configured for tool-less engagement and locking.

13. The system according to claim 5, wherein said filter bowl shield body bottom wall or surface comprises an opening.

14. The system according to claim 5, wherein said filter bowl shield body bottom wall or surface comprises a cup inserted within said bottom wall surface or wall opening.

15. The system according to claim 14, wherein said filter bowl shield cup is sized and shaped to cover a fuel filter bowl quick drain.
